(19) United States
(12) Patent Application Publication
(10) Pub. No.: US 2021/0226380 A1
(43) Pub. Date: Jul. 22, 2021

(54) LEVER-TYPE CONNECTOR

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Shingo KOBAYASHI, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/769,081

(22) PCT Filed: Dec. 3, 2018
(86) PCT No.: PCT/JP2018/044337

§ 371 Date: Jun. 2, 2020

(30) Foreign Application Priority Data
Dec. 18, 2017 (JP) 2017-241768

(51) Int. Cl. H01R 13/533; H01R 13/629; H01R 13/639

(52) U.S. Cl. CPC H01R 13/533; H01R 13/639; H01R 13/62938

(57) ABSTRACT

A lever connector, including: a terminal block that includes a fitting portion, a first pin and a second pin, the first pin and the second pin being provided to project from an outer periphery of the fitting portion and arranged orthogonal to each other; a housing that includes a receptacle, the fitting portion being fittable into the receptacle; a first lever mounted on the housing, the first lever fitting and separating the fitting portion into and from the receptacle by being engaged with the first pin; and a second lever mounted on the receptacle, the second lever being movable between a locking position where the second lever is locked to the second pin and a non-locking position where the second lever is not locked to the second pin.

### BACKGROUND

A technique disclosed by this specification relates to a lever-type connector.

Conventionally, a connector system with a wiring harness connector connectable to an interface of a unit is known from Japanese Unexamined Patent Application Publication No. 2016-531393. The wiring harness connector includes a first fixing member and a second fixing member. The second fixing member directly fixes a conductive wire and the wiring harness connector to the unit without play in addition to original connector locking by the first fixing member. Since the interface and the wiring harness connector have the same vibration level in this way, the wear of electrical contact elements of the connector system is suppressed to a minimum.

### SUMMARY

However, since a lock member to which the second fixing member is fixed is provided in the unit in the above connector system and anti-vibration measures cannot be established without a design change of the unit, the measures cannot be easily taken. Thus, it is most desirable to take anti-vibration measures only by a design change of the wiring harness connector without being accompanied by a design change of the unit.

A lever-type connector disclosed by this specification is provided with a terminal block that includes a fitting portion, a first pin and a second pin, the first pin and the second pin being provided to project from an outer periphery of the fitting portion and arranged orthogonal to each other; a housing that includes a receptacle, the fitting portion being fittable into the receptacle, a first lever mounted on the housing, the first lever fitting and separating the fitting portion into and from the receptacle by being engaged with the first pin, and a second lever mounted on the receptacle, the second lever being movable between a locking position where the second lever is locked to the second pin and a non-locking position where the second lever is not locked to the second pin, the second pin including a shaft coupled to the outer periphery of the fitting portion and a flange located on a tip of the shaft and having a larger diameter than the shaft, and the second lever being locked to the flange on both front and rear sides in a fitting direction of the fitting portion with the shaft as a center at the locking position.

According to this configuration, the fitting is made to progress by moving the first lever and engaging the first lever with the first pin after the fitting portion is lightly fit into the receptacle. If the second lever is moved from the non-locking position to the locking position after the fitting of the receptacle and the fitting portion is completed, the flange comes into contact with the second lever on both front and rear sides of the shaft.

Here, if the housing is going to move in a lateral direction, a movement of the housing in the lateral direction is suppressed since the first lever is engaged with the first pin. Further, if the housing is going to move in a vertical direction, a movement of the housing in the vertical direction is suppressed since the second lever is engaged with the flange of the second pin. Thus, movements of the housing can be suppressed in both lateral and vertical directions and anti-vibration measures can be taken only by design changes of the housing and the terminal block without being accompanied by a design change on the side of a device on which the terminal block is mounted.

The lever-type connector disclosed by this specification may be configured as follows.

The fitting portion of the terminal block may have a substantially rectangular shape laterally long in a front view, and a pair of the second pins may be provided side by side in a transverse direction on a long side part extending in the transverse direction, out of the outer periphery of the fitting portion.

According to this configuration, since the pair of second pins are provided side by side in the transverse direction, the shaking of the housing in the vertical direction can be more suppressed and, if the housing is going to move in a rotating direction about an axis extending in the fitting direction, the shaking in the rotating direction can be suppressed.

A pair of the second pins may be provided side by side in the transverse direction on one of the long side parts and a pair of the second pins may be provided side by side in the transverse direction on the other long side part.

According to this configuration, since the shaking of the housing can be suppressed by each of the pair of long side parts, the shaking is more easily suppressed than in the case of suppressing the shaking by one long side part.

The second lever may include a groove into which the shaft is inserted, and the groove may be composed of a longitudinal groove extending in the fitting direction of the fitting portion and a transverse groove arranged orthogonal to the longitudinal groove.

According to this configuration, the shaft moves in the longitudinal groove in fitting the fitting portion into the receptacle, and moves in the transverse groove in moving the second lever from the non-locking position to the locking position after the fitting is completed. Therefore, both side parts of the transverse groove are locked to the flange.

According to the lever-type connector disclosed by this specification, it is possible to take anti-vibration measures only by design changes of the housing and the terminal block without being accompanied by a design change on the side of a device on which the terminal block is mounted.

### BRIEF DESCRIPTION OF THE DRAWINGS

FIG. 1 is a perspective view of a lever-type connector before a terminal block and a housing are connected,

FIG. 2 is a perspective view of the lever-type connector showing a state where the terminal block and the housing are connected and second levers are at a non-locking position,

FIG. 3 is a perspective view of the lever-type connector showing a state where the second levers are at a locking position,

FIG. 4 is a plan view of the lever-type connector showing a state where the second levers are at the non-locking position,

FIG. 5 is a bottom view of the lever-type connector showing the state where the second levers are at the non-locking position,

FIG. 6 is a side view of the lever-type connector showing a state where a first lever is at an initial position,

FIG. 7 is a side view partly cut away of a part of FIG. 6 enlargedly showing the second lever,

FIG. 8 is a front view of the housing showing the state where the first lever is at the initial position,

FIG. 9 is a back view of the housing showing the state where the first lever is at the initial position,

FIG. 10 is a plan view of the lever-type connector showing the state where the second levers are at the locking position,

FIG. 11 is a section along A-A of FIG. 10,

FIG. 12 is a section along B-B of FIG. 10,

FIG. 13 is a side view of the lever-type connector showing a state where the first lever is at a connection position,

FIG. 14 is a section along C-C of FIG. 13,

FIG. 15 is a bottom view of the lever-type connector showing the state where the second levers are at the locking position,

FIG. 16 is a plan view of the terminal block,

FIG. 17 is a front view of the terminal block, and

FIG. 18 is a side view of the terminal block.

### DETAILED DESCRIPTION OF EMBODIMENTS

### Embodiment

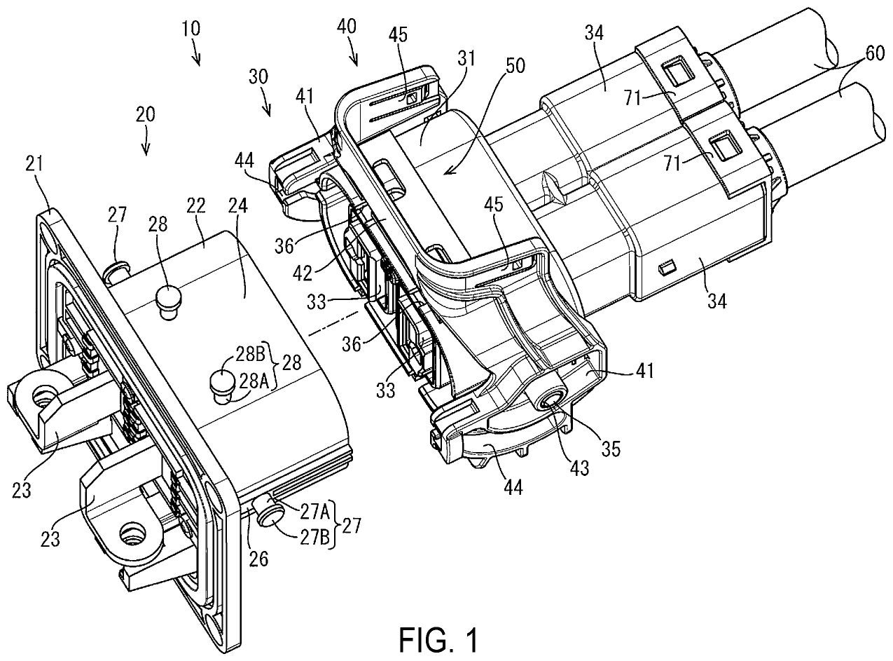

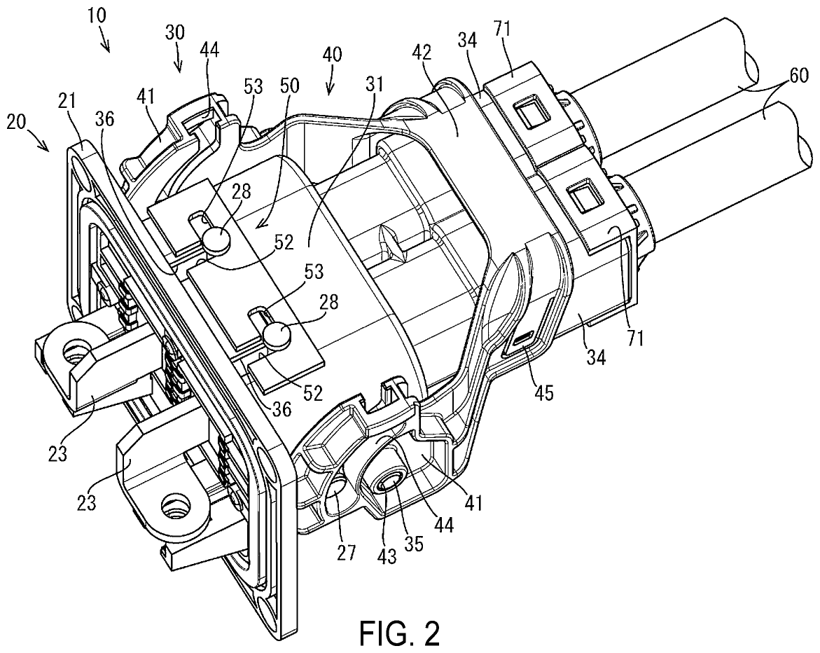

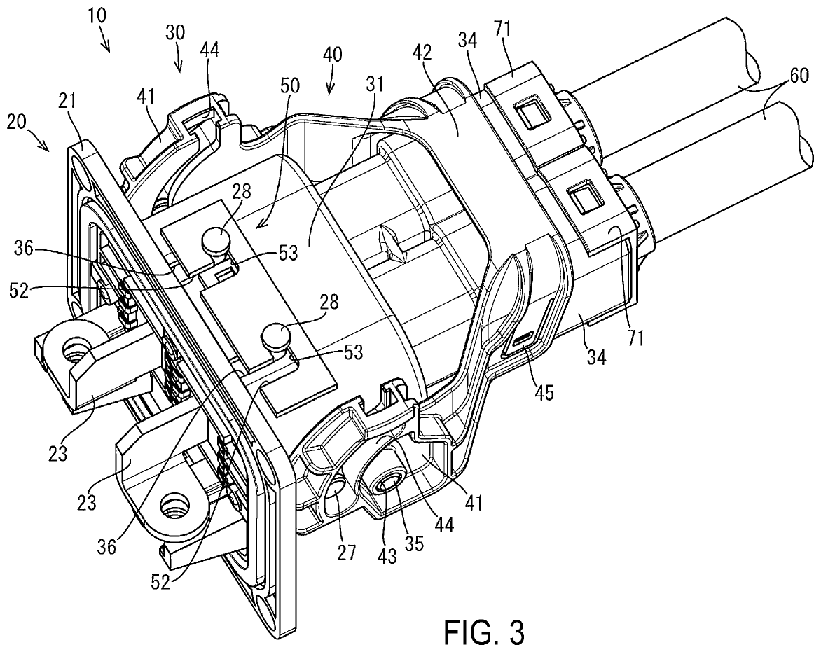

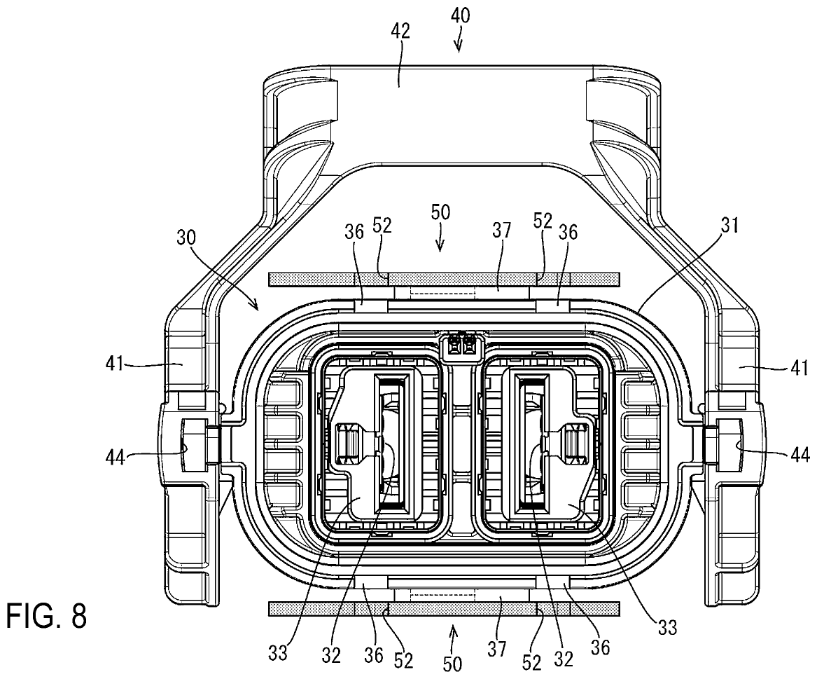

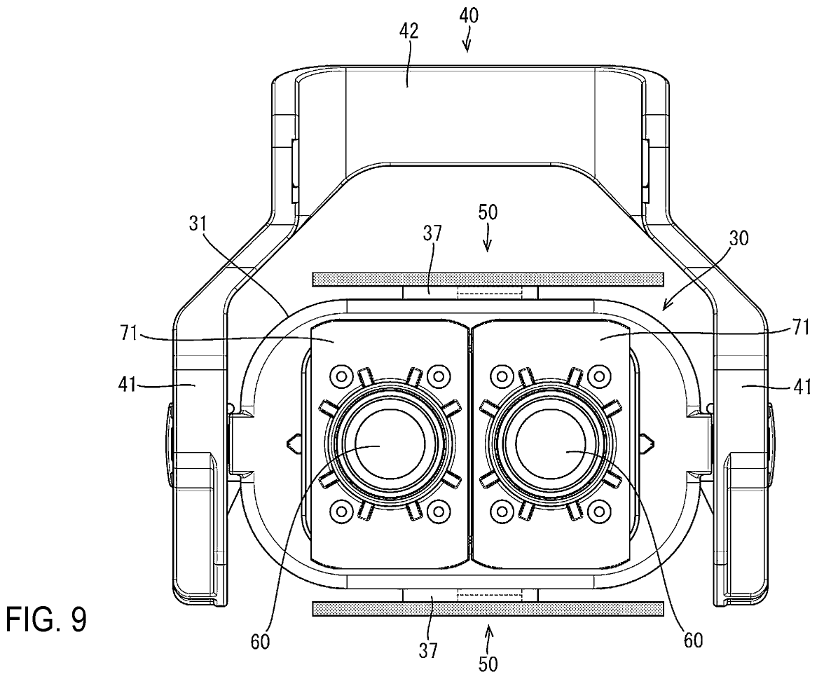

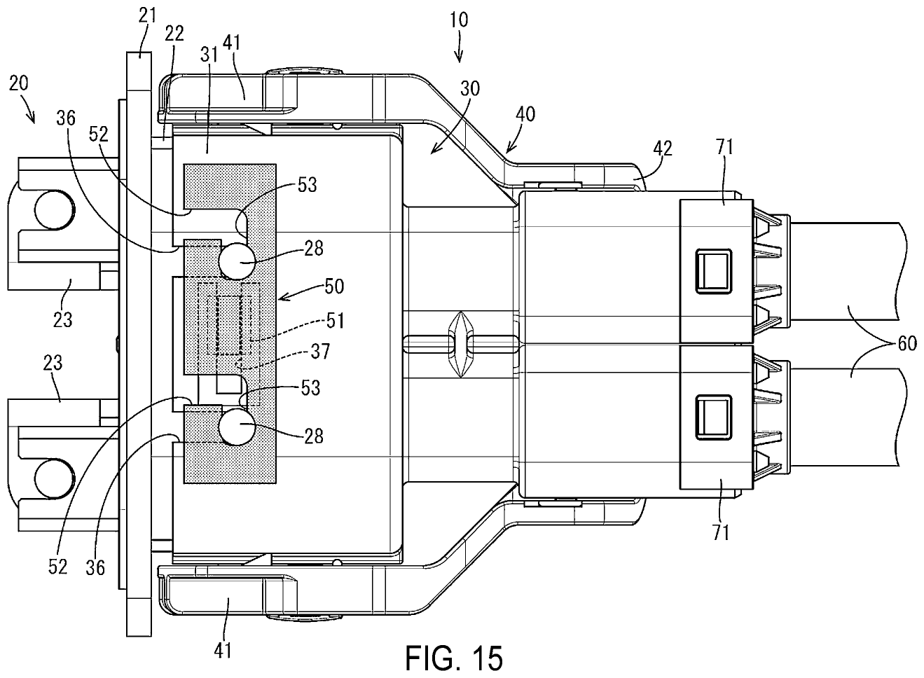

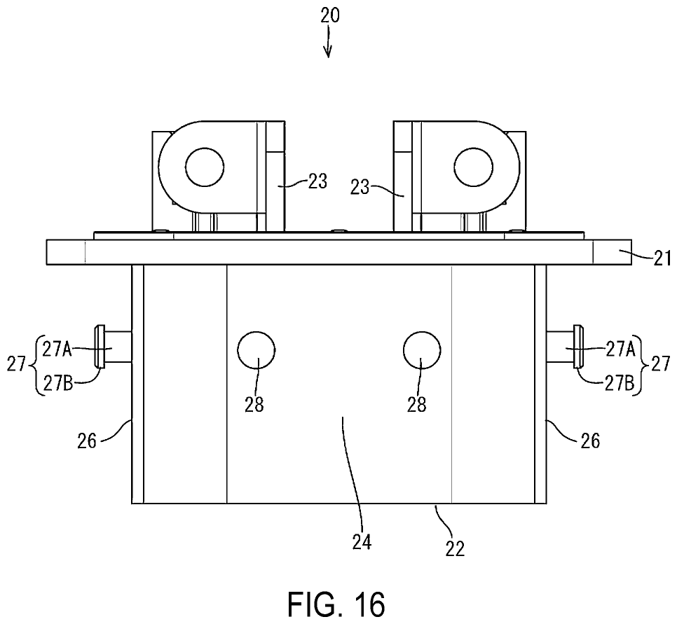

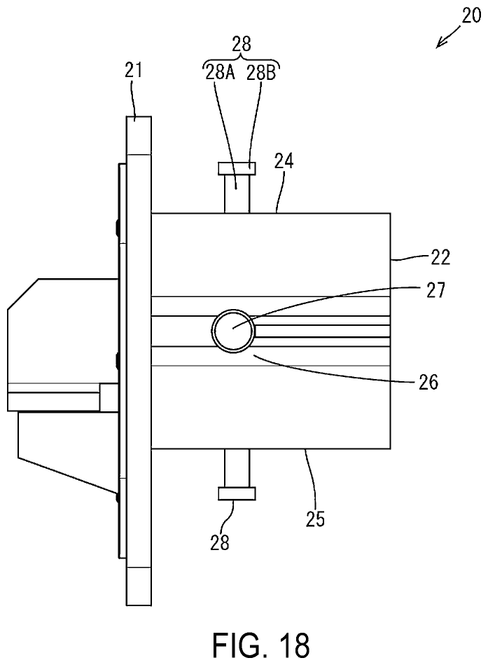

An embodiment is described with reference to FIGS. 1 to 18. A lever-type connector 10 of this embodiment includes a terminal block 20, a housing 30, a first lever 40 and second levers 50 as shown in FIG. 1. The first lever 40 is mounted rotatably with respect to the housing 30 and movable between an initial position shown in FIG. 1 and a connection position shown in FIG. 2. Further, the second levers 50 are mounted slidably with respect to the housing 30 and movable between a non-locking position shown in FIG. 2 and a locking position shown in FIG. 3.

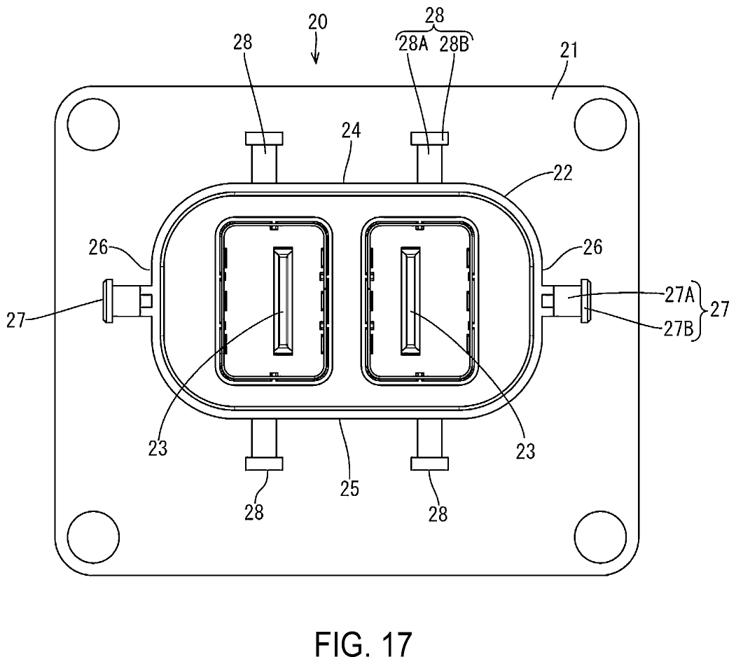

The terminal block 20 includes a mounting plate 21 to be mounted on an unillustrated device, a fitting portion 22 provided to project forward from the mounting plate 21, a pair of male terminals 23 held inside the fitting portion 22 and the like. As shown in FIG. 17, the fitting portion 22 has a rectangular shape laterally long in a front view. An upper surface part 24 and a lower surface part 25 of the fitting portion 22 are longer than both side surface parts 26. Further, the male terminals 23 are in the form of flat tabs.

A first pin 27 is provided on each of the both side surface parts 26. The first pins 27 laterally project in opposite directions. Further, a pair of left and right second pins 28 are provided on the upper surface part 24 to project upward while being arranged in a transverse direction, and a pair of left and right second pins 28 are provided on the lower surface part 25 to project downward while being arranged in the transverse direction. The pair of left and right second pins 28 on an upper side and the pair of left and right second pins 28 on a lower side are aligned in a vertical direction. The pair of first pins 27 and four second pins 28 are arranged in a circumferential direction.

The first pin 27 includes a first shaft portion 27A coupled to the side surface part 26 and a first flange portion 27B located on the tip of the first shaft portion 27A, having a larger diameter than the first shaft portion 27A and arranged coaxially with the first shaft portion 27A. Similarly, the second pin 28 includes a second shaft portion 28A coupled to the upper or lower surface part 24, 25 and a second flange portion 28B located on the tip of the second shaft portion 28A, having a larger diameter than the second shaft portion 28A and arranged coaxially with the second shaft portion 28A.

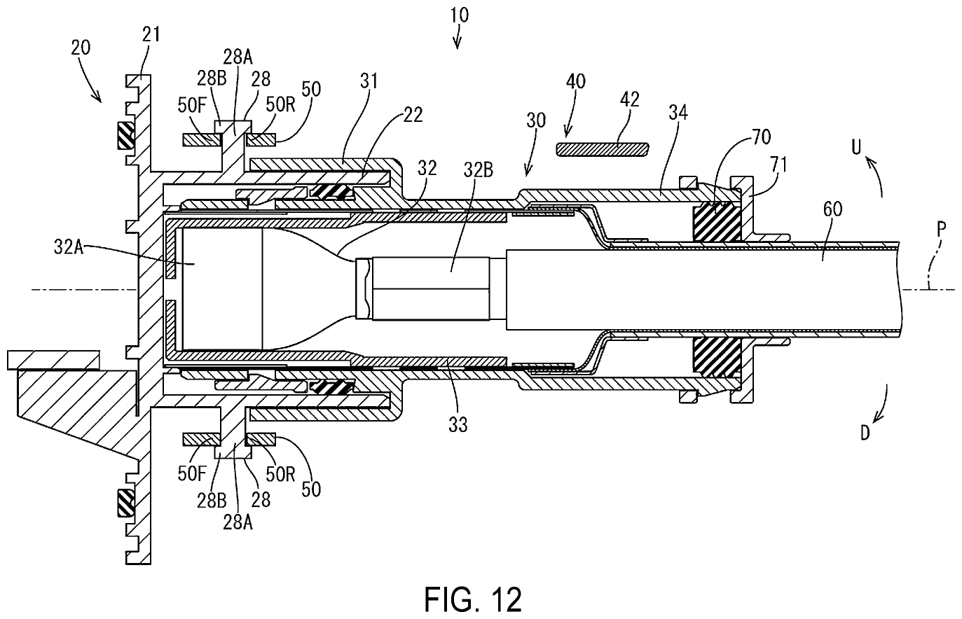

The housing 30 is made of synthetic resin and includes, as shown in FIG. 1, a receptacle 31 into which the fitting portion 22 is fit. The receptacle 31 is open forward, and a pair of female terminals 32 and a pair of terminal holding portions 33 for holding the female terminals 32 inside are provided inside the receptacle 31. If the fitting portion 22 is fit into the receptacle 31, the pair of male terminals 23 and the pair of female terminals 32 are conductively connected. As shown in FIG. 12, the female terminal 32 includes a terminal connecting portion 32A to be connected to the male terminal 23 and a wire connecting portion 32B connected to an end of a wire 60. The wire 60 is pulled out rearwardly from the housing 30.

Rubber plug accommodating portions 34 for accommodating rubber plugs 70 together with the wires 60 are provided behind the receptacle 31 in the housing 30. The rubber plug 70 is accommodated in a rear end of the rubber plug accommodating portion 34 and retained by a back retainer 71. The rubber plug 70 is held in close contact with both the outer peripheral surface of the wire 60 and the inner peripheral surface of the rubber plug accommodating portion 34 to prevent the intrusion of water into the rubber plug accommodating portion 34 from behind.

A pair of lever shaft portions 35 are provided to project in opposite directions on both side surfaces of the receptacle 31. On the other hand, as shown in FIG. 1, the first lever 40 includes a pair of cam plates 41 and an operating portion 42 coupling the both cam plates 41. The cam plates 41 are provided with shaft holes 43 and the lever shaft portions 35 are inserted into these shaft holes 43. In this way, the first lever 40 is enabled to rotate about the pair of lever shaft portions 35.

The cam plate 41 is formed with a cam groove 44. As shown in FIG. 1, when the first lever 40 is at the initial position, the entrances of the cam grooves 44 are open forward. Thus, if the fitting portion 22 is lightly fit into the receptacle 31, the first pins 27 enter the entrances of the cam grooves 44. If the first lever 40 is moved from the initial position to the connection position by being rotated thereafter, the first pins 27 and the inner walls of the cam grooves 44 are engaged to display a cam action, whereby the fitting of the fitting portion 22 and the receptacle 31 progresses. When the first lever 40 reaches the connection position, the fitting of the fitting portion 22 and the receptacle 31 is completed as shown in FIG. 2. On the contrary, if the first lever 40 is rotated from the connection position to the initial position, the separation of the fitting portion 22 and the receptacle 31 progresses and, at the initial position, is completed by manually pulling apart the fitting portion 22 and the receptacle 31.

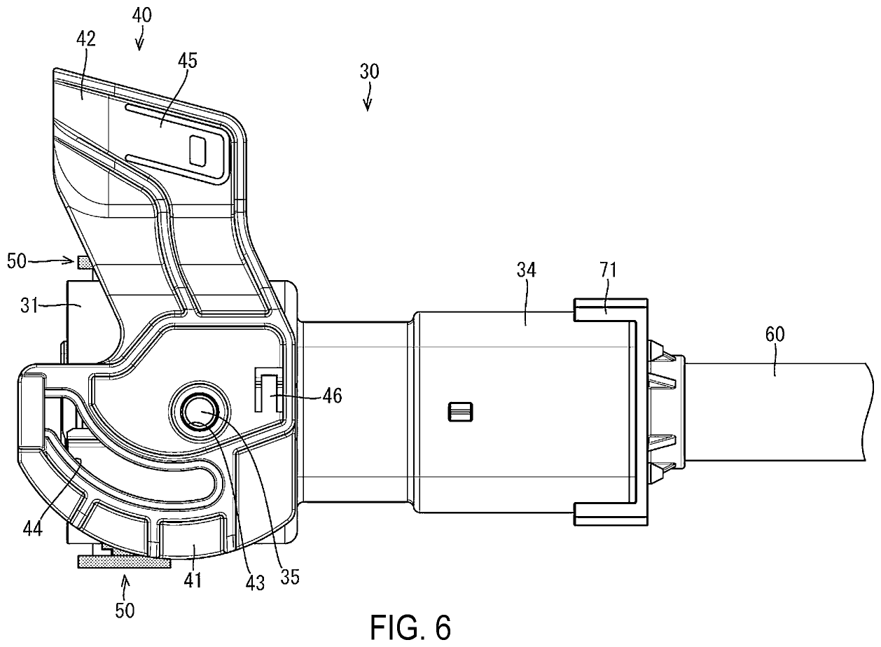

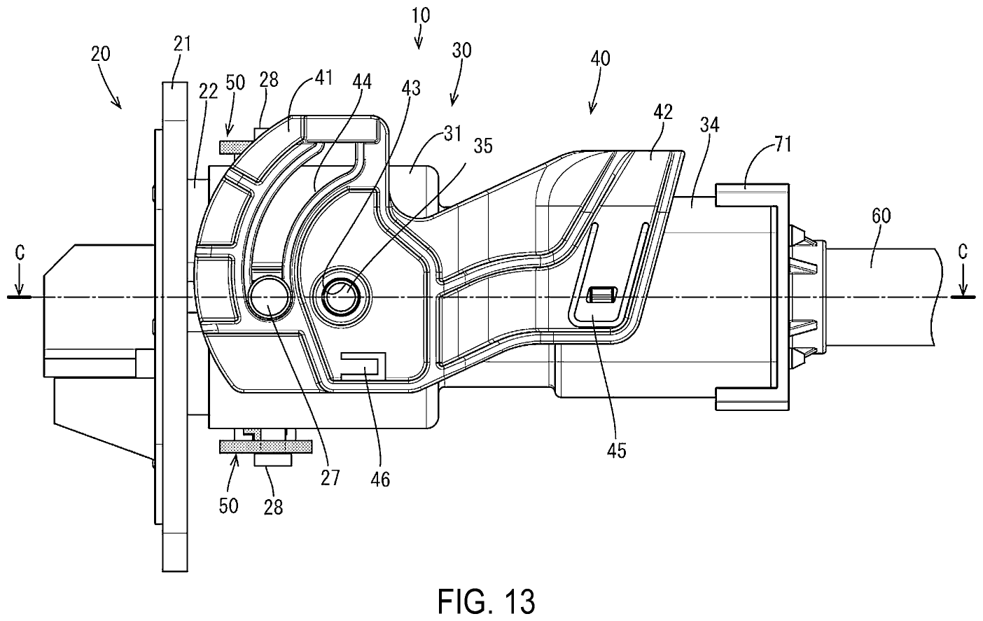

As shown in FIG. 6, a pair of connection position lock portions 45 are provided on both sides of the operating portion 42 of the first lever 40, and a pair of initial position lock portions 46 are provided on the both cam plates 41. The first lever 40 is held at the initial position by the initial position lock portions 46 being locked to projections provided on side parts of the receptacle 31. Further, as shown in FIG. 13, the first lever 40 is held at the connection position by the connection position lock portions 45 being locked to projections provided on side parts of the rubber plug accommodating portions 34.

As shown in FIG. 1, insertion grooves 36 into which the second pins 28 are inserted are provided in the front edge of the receptacle 31. The insertion grooves 36 extend straight rearward from the front edge of the receptacle 31. Further, the insertion grooves 36 are disposed to correspond to the positions of the second pins 28 at the non-locking position. A pair of the insertion grooves 36 are provided on each of both upper and lower sides of the receptacle 31.

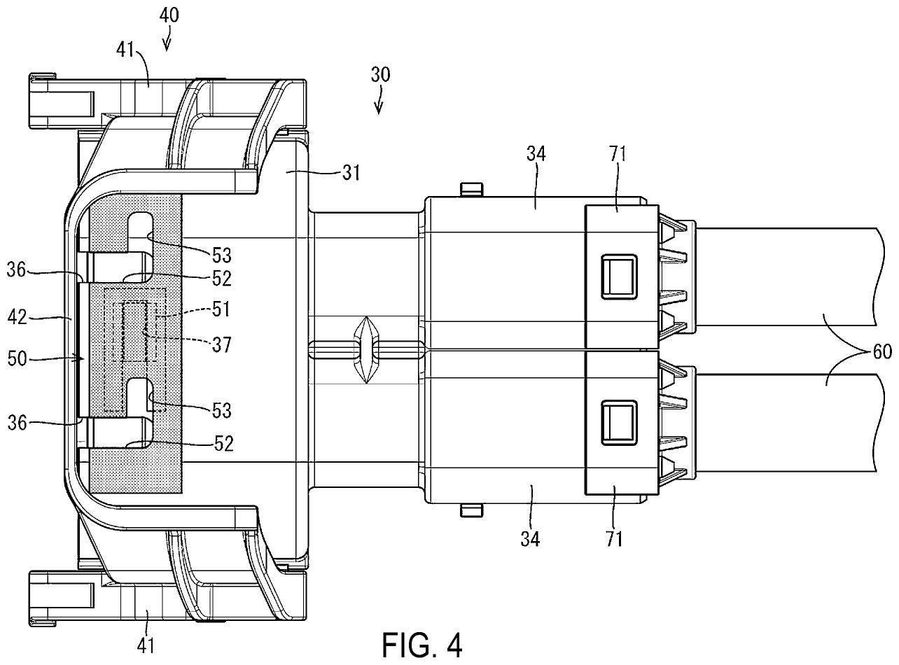

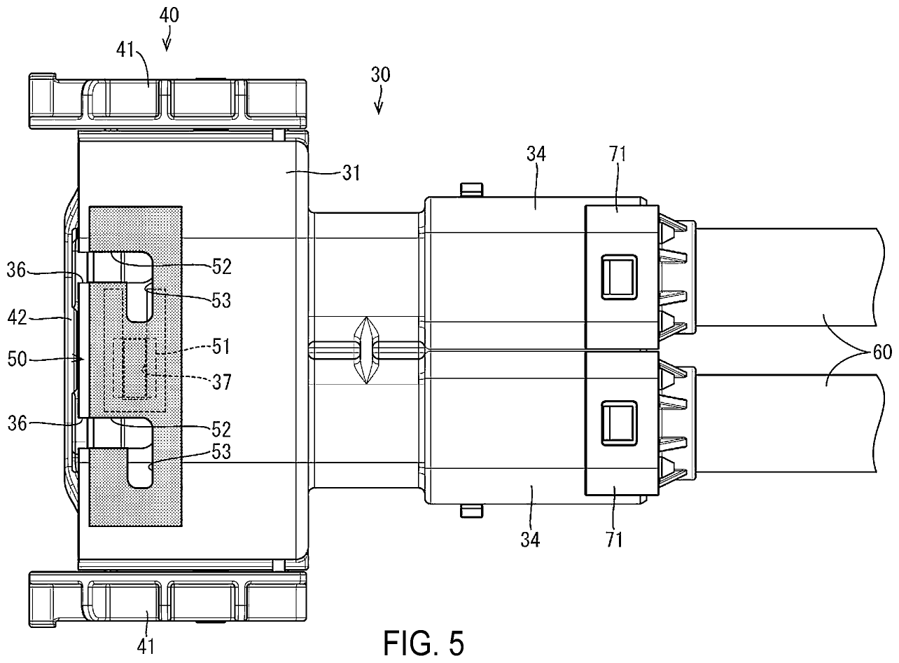

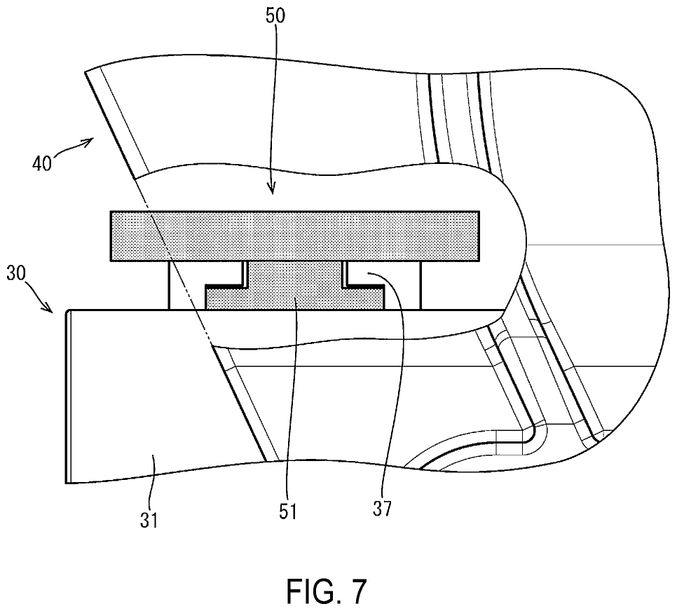

As shown in FIGS. 4 and 5, a pair of the second levers 50 are mounted on both upper and lower sides of the receptacle 31. The second lever 50 has a rectangular shape laterally long in a plan view and is slidable in a direction orthogonal to a fitting direction of the fitting portion 22 and the receptacle 31. This sliding structure is, as shown in FIG. 7, composed of a guide recess 37 in the form of a dovetail groove and projecting from the outer periphery of the receptacle 31 and a guide protrusion 51 provided to project from the second lever 50. The second lever 50 moves in parallel to the outer periphery of the receptacle 31 without separating from the receptacle 31 by a movement of the guide protrusion 51 along the guide recess 37.

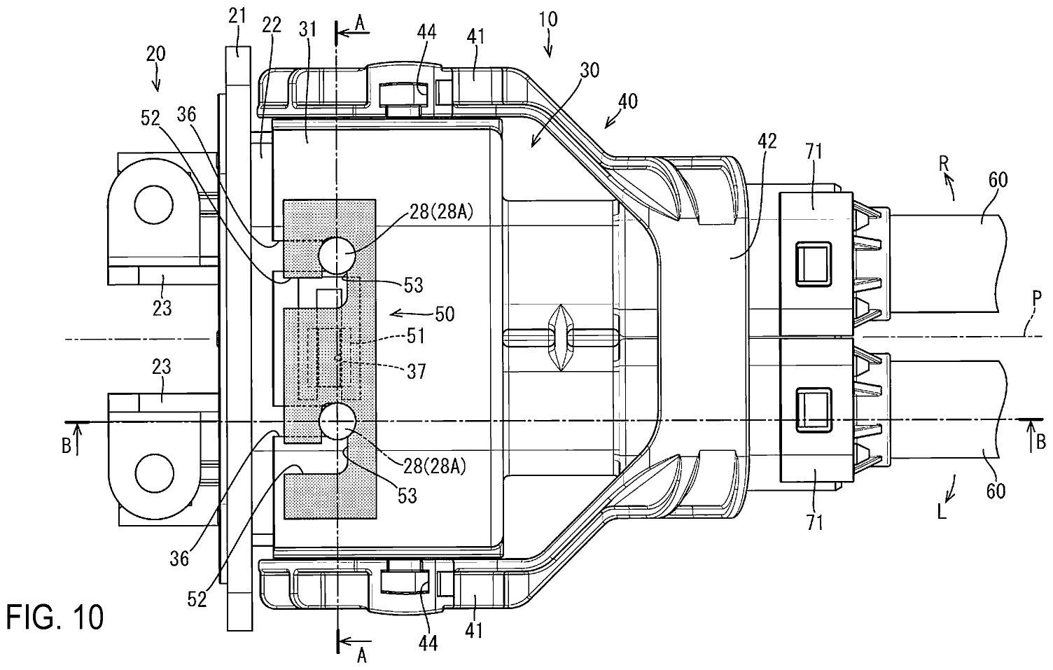

As shown in FIG. 4, the second lever 50 includes L-shaped grooves each composed of a longitudinal groove 52 and a transverse groove 53. The longitudinal grooves 52 are aligned with the insertion grooves 36 of the receptacle 31 at the non-locking position. Thus, the second shaft portions 28A move from the entrances to the back ends of the longitudinal grooves 52 in fitting the fitting portion 22 into the receptacle 31. When the fitting is completed, the second shaft portions 28A reach the back ends of the longitudinal grooves 52. To move the second lever 50 from the non-locking position to the locking position after the fitting of the fitting portion 22 and the receptacle 31 is completed, the second shaft portions 28A move from the entrances to the back ends of the transverse grooves 53 as shown in FIG. 10. When the second lever 50 reaches the locking position, the second shaft portions 28A reach the back ends of the transverse grooves 53. At this time, since the insertion grooves 36 and the longitudinal grooves 52 are arranged not to overlap each other in a plan view, the second pins 28 do not move forward of the receptacle 31 through the insertion grooves 36.

In the lever-type connector 10 of this embodiment, anti-vibration measures in various directions are taken by the first and second levers 40, 50.

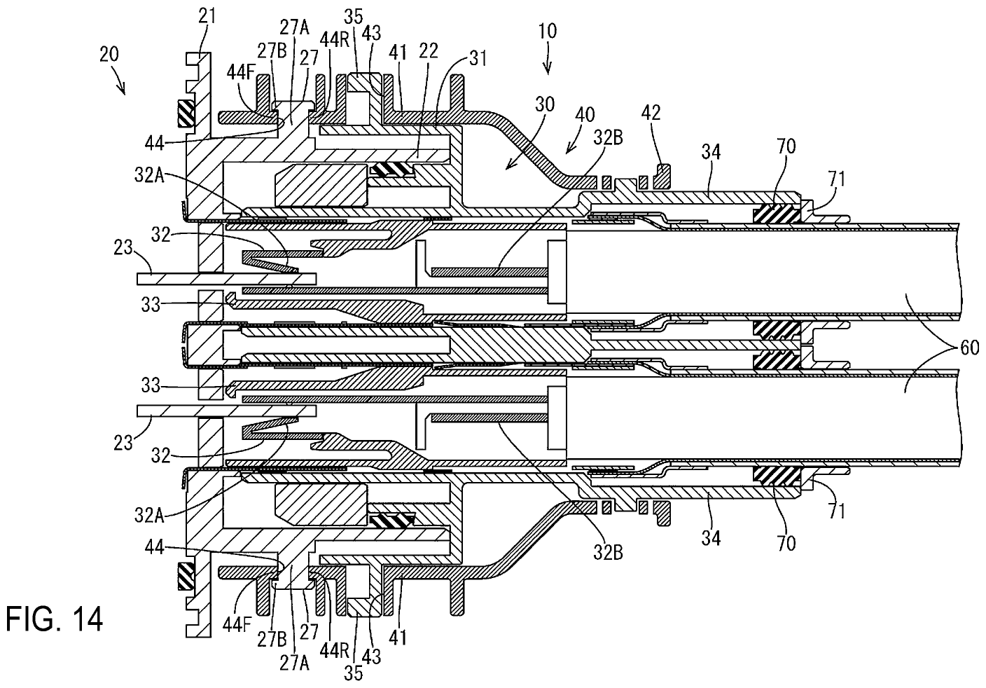

First, the anti-vibration measure in the lateral direction is described. Here, the lateral direction is a vertical direction of FIG. 10 and indicated by arrows L, R, wherein L means a left side and R means a right side. If the wires 60 are shaken in the lateral direction, the housing 30 is also accordingly going to move in the lateral direction. However, the first pins 27 are engaged with the cam grooves 44 to suppress a movement in the lateral direction as shown in FIG. 14. More particularly, the movement in the lateral direction is suppressed by the contact of pairs of bottom walls 44F, 44R of the inner walls of the cam grooves 44 located on both front and rear sides of the first shaft portions 27A with the first flange portions 27B. If the wires 60 are shaken to the left side L, the front bottom wall 44F is locked to the first flange portion 27B on the right first pin 27 and the rear bottom wall 44R is locked to the first flange portion 27B on the left first pin 27, whereby a movement of the housing 30 to the left side L is suppressed. On the contrary, if the wires 60 are shaken to the right side R, the rear bottom wall 44R is locked to the first flange portion 27B on the right first pin 27 and the front bottom wall 44F is locked to the first flange portion 27B on the left first pin 27, whereby a movement of the housing 30 to the right side R is suppressed.

Next, the anti-vibration measure in the vertical direction is described. Here, the vertical direction is a vertical direction of FIG. 12 and indicated by arrows U, D, wherein U means an upper side and D means a lower side. If the wires 60 are shaken in the vertical direction, the second levers 50 are locked to the second pins 28, whereby a movement in the vertical direction is suppressed. Specifically, the movement in the vertical direction is suppressed by front walls 50F of the second levers 50 located in front of the second shaft portions 28A and rear walls 50R thereof located behind the second flange portions 28B and the second flange portions 28B locking each other. If the wires 60 are shaken to the upper side U, the rear wall 50R is locked to the second flange portions 28B on the upper second pins 28 and the front wall 50F is locked to the second flange portions 28B on the lower second pins 28, whereby a movement of the housing 30 to the upper side U is suppressed. On the contrary, if the wires 60 are shaken to the lower side D, the front wall 50F is locked to the second flange portions 28B on the upper second pins 28 and the rear wall 50R is locked to the second flange portions 28B on the lower second pins 28, whereby a movement of the housing 30 to the lower side D is suppressed.

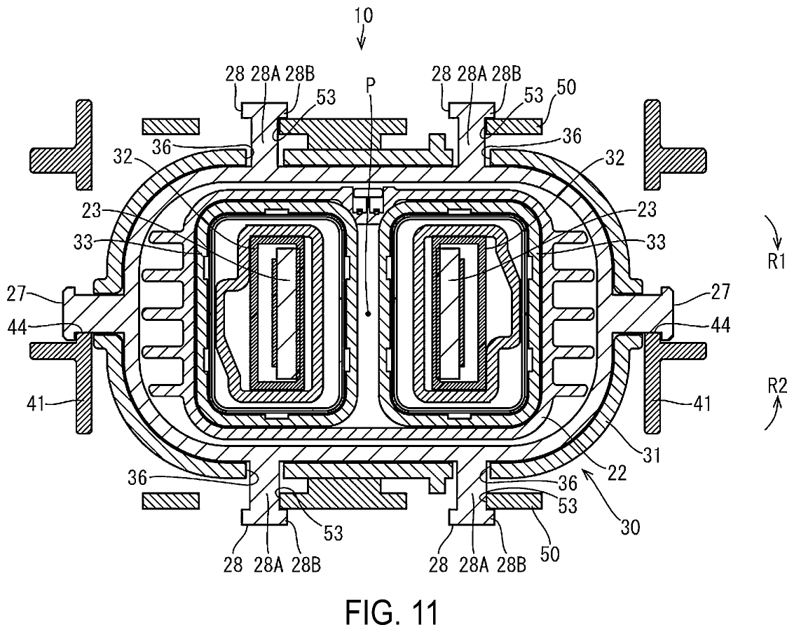

Next, the anti-vibration measure in rotating directions about an axis P (see FIGS. 10 and 11) extending in the fitting direction is described. Here, the axis P is an axis extending in the fitting direction at a middle position between a pair of the wires 60. Further, the rotating directions are directions indicated by arrows R1, R2 in FIG. 11, wherein R1 means a clockwise direction and R2 means a counterclockwise direction. If the wires 60 are shaken in the clockwise direction R1, the second levers 50 are locked to the second flange portions 28B on the left-upper and right-lower second pins 28, whereby a movement of the housing 30 in the clockwise direction R1 is suppressed. On the contrary, if the wires 60 are shaken in the counterclockwise direction R2, the second levers 50 are locked to the second flange portions 28B on the right-upper and left-lower second pins 28, whereby a movement of the housing 30 in the counterclockwise direction R1 is suppressed.

As just described, movements of the housing 30 in the lateral direction are suppressed by the first lever 40 and movements thereof in the vertical direction and rotating directions are suppressed by the second levers 50. Thus, even if the entire lever-type connector 10 is subjected to vibration, relative movements of the terminal block 20 and the housing 30 can be suppressed and the wear of contact portions of the both terminals 23, 32 can be avoided.

As described above, in this embodiment, the fitting is made to progress by moving the first lever 40 and engaging the first lever 40 with the first pins 27 after the fitting portion 22 is lightly fit into the receptacle 31. If the second levers 50 are moved from the non-locking position to the locking position after the fitting of the receptacle 31 and the fitting portion 22 is completed, the second flange portions 28B come into contact with the second levers 50 on both front and rear sides of the second shaft portions 28A.

Here, if the housing 30 is going to move in the lateral direction, a movement of the housing 30 in the lateral direction is suppressed since the first lever 40 is engaged with the first pins 27. Further, if the housing 30 is going to move in the vertical direction, a movement of the housing 30 in the vertical direction is suppressed since the second levers 50 are engaged with the second flange portions 28B of the second pins 28. Thus, movements of the housing 30 can be suppressed in both lateral and vertical directions and anti-vibration measures can be taken only by design changes of the housing 30 and the terminal block 20 without being accompanied by a design change on the side of a device on which the terminal block 20 is mounted.

The fitting portion 22 of the terminal block 20 may have a substantially rectangular shape laterally long in a front view and a pair of the second pins 28 may be provided side by side in the transverse direction on a long side part (upper surface part 24) extending in the transvers direction, out of the outer periphery of the fitting portion 22.

According to this configuration, since the pair of second pins 28 are provided side by side in the transverse direction, the shaking of the housing 30 in the vertical direction can be more suppressed and the shaking in the rotating direction can be suppressed if the housing 30 is going to move in the rotating direction about the axis P extending in the fitting direction.

A pair of the second pins 28 may be provided side by side in the transverse direction on one long side part and a pair of the second pins 28 may be provided side by side in the transverse direction on the other long side part.

According to this configuration, the shaking of the housing 30 can be suppressed by a pair of the long side parts, wherefore the shaking is more easily suppressed than in the case of suppressing the shaking by one long side part.

The second lever 50 may include the grooves and each of these grooves may be composed of the longitudinal groove 52 extending in the fitting direction of the fitting portion 22 and the transverse groove 53 arranged orthogonal to the longitudinal groove 52.

According to this configuration, the second shaft portions 28A move in the longitudinal grooves 52 in fitting the fitting portion 22 into the receptacle 31, and the second shaft portions 28A move in the transverse grooves 53 in moving the second lever 50 from the non-locking position to the locking position after the fitting is completed. Thus, both side parts of the transverse grooves 53 are locked to the second flange portions 28B.

### Other Embodiments

The technique disclosed by this specification is not limited to the above described and illustrated embodiment. For example, the following various modes are also included.

(1) Although the second lever 50 of a sliding type is illustrated in the above embodiment, a second lever of a rotating type may be used. Further, although the first lever 40 of a sliding type is illustrated in the above embodiment, a first lever of a sliding type may be used.

(2) Although a moving direction of the second lever 50 is orthogonal to the fitting direction in the above embodiment, a moving direction of a second lever may be the same as the fitting direction.

(3) Although the pair of second pins 28 are provided on the long side part (upper surface part 24, lower surface part 25) extending in the transverse direction, out of the outer periphery of the fitting portion 22, in the above embodiment, only one second pin may be provided on the long side part.

(4) Although the second lever 50 includes the longitudinal grooves 52 and the transverse grooves 53 in the above embodiment, a second lever may include only a transverse groove.

1. A lever connector, comprising:
a terminal block that includes a fitting portion, a first pin and a second pin, the first pin and the second pin being provided to project from an outer periphery of the fitting portion and arranged orthogonal to each other;
a housing that includes a receptacle, the fitting portion being fittable into the receptacle;
a first lever mounted on the housing, the first lever fitting and separating the fitting portion into and from the receptacle by being engaged with the first pin; and
a second lever mounted on the receptacle, the second lever being movable between a locking position where the second lever is locked to the second pin and a non-locking position where the second lever is not locked to the second pin,
the second pin including a shaft coupled to the outer periphery of the fitting portion and a flange located on a tip of the shaft and having a larger diameter than the shaft, and
the second lever being locked to the flange on both front and rear sides in a fitting direction of the fitting portion with the shaft as a center at the locking position.

2. The lever connector according to claim 1, wherein the fitting portion of the terminal block has a substantially rectangular shape laterally long in a front view, and a pair of the second pins are provided side by side in a transverse direction on a long side part extending in the transverse direction, out of the outer periphery of the fitting portion.

3. The lever connector according to claim 2, wherein a pair of the second pins are provided side by side in the transverse direction on one of the long side parts and a pair of the second pins are provided side by side in the transverse direction on the other long side part.

4. The lever connector according to claim 1, wherein the second lever includes a groove into which the shaft is inserted, and the groove is composed of a longitudinal groove extending in the fitting direction of the fitting portion and a transverse groove arranged orthogonal to the longitudinal groove.
